(19) United States
(12) Patent Application Publication
(10) Pub. No.: US 2021/0257964 A1
(43) Pub. Date: Aug. 19, 2021

(54) TRUSS FOUNDATIONS FOR SINGLE-AXIS TRACKERS

(71) Applicant: Ojjo, Inc., San Rafael, CA (US)

(72) Inventors: Tyrus Hudson, Petaluma, CA (US); Katie Pesce, El Cerrito, CA (US); Greg McPheeters, Santa Cruz, CA (US); Charles Almy, Berkeley, CA (US)

(21) Appl. No.: 17/179,156

(22) Filed: Feb. 18, 2021

Related U.S. Application Data
(60) Provisional application No. 62/977,888, filed on Feb. 18, 2020.

(51) Int. Cl. H02S 20/32; F24S 25/13; F24S 25/617; F24S 25/65; F24S 25/70; F24S 30/425

(52) U.S. Cl. CPC H02S 20/32; F24S 25/13; F24S 30/425; F24S 25/65; F24S 25/70; F24S 25/617

(57) ABSTRACT

Truss foundations for supporting single-axis trackers. A motor truss may be constructed from a pair of adjacent trusses that are braced and interconnected to resist axial loads and bending moments experienced at the drive motor or center structure. Dampers may be added to one or more trusses to protect the tracker from unintended rotation by resisting these forces with the truss legs.

### CROSS-REFERENCE TO RELATED APPLICATIONS

This claims priority to U.S. provisional patent application No. 62/977,888 filed on Feb. 18, 2020, titled “SINGLE-AXIS TRACKERS SUPPORTED BY TRUSS FOUNDATIONS”, the disclosure of which is hereby incorporated by reference in its entirety.

### BACKGROUND

Single-axis trackers are becoming the dominant form factor for utility scale solar power plants. These systems consist of North-South oriented rows of panels arranged to rotate from East to West on a common torque tube. Until recently, single-axis solar trackers have been supported by plumb-driven monopile foundations such as standard wide flange W6×9 or W6×12 galvanized H-piles. These piles are beaten into the ground along the intended tracker row and tracker components are subsequently attached to the top of them via pre-drilled holes and/or other preformed features.

In addition to resisting the weight of the array, when supporting a single-axis tracker, the foundation must be able to withstand lateral loads due to wind impinging on the array. With a monopile foundation, lateral wind loads impart a bending moment to the foundation. Because single structural members are relatively poor at resisting moments, larger sized beams must be used with deeper embedment depths that would be necessary merely to support the weight.

The applicant of this disclosure as developed an alternative to plumb driven monopile foundations that relies on a pair of angled legs that form a truss with the ground. The above ground ends of each leg are joined with a truss cap, adapter or bearing adapter to form a unitary structure and interface that accepts various third-party tracker systems. Known commercially as EARTH TRUSS, this system is better suited to supporting single-axis tracker than H-piles because it is able to translate lateral loads into axial forces of tension and compression in the truss legs. Single structural members are good at resisting axial forces relative to their ability to resist moments. As a result, less steel is required, and shallower embedment depths may be used to support the same sized array relative to H-piles.

While the EARTH TRUSS foundation outperforms H-piles in most applications, it bears mention that the top-of-pile loads specified by tracker makers are not the same across an entire array. For example, foundations that support drive motor assemblies and those with dampers may experience greater lateral loads and/or bending moments, not felt by other foundations in the array. With H-piles, this variance is accommodated by using heavier gauge beams and/or with deeper embedment depths. In order to maximize EARTH TRUSS's market acceptance, the system must also accommodate these special cases, preferably with the same components used in the standard case, and to installed using the same equipment used on the more common standard trusses. To that end, various embodiments of this disclosure provide truss foundations that are capable of withstanding the additional forces experienced at the drive motor and at foundations with damper assemblies.

### BRIEF DESCRIPTION OF THE DRAWINGS

FIGS. 1A and 1B show front and exploded views respectively of a truss foundation for supporting single-axis trackers in accordance with various embodiments of the invention;

FIGS. 2A and 2b show front and exploded views respectively of a bearing housing assembly and truss cap according to various embodiments of the invention;

FIG. 3A shows a portion of a single-axis tracker including a standard bearing truss, motor truss, and damper truss according to various embodiments of the invention;

FIG. 3B shows a side view of a portion of a single-axis tracker including a motor truss and a bearing truss according to various embodiments of the invention;

FIGS. 4A, 4B and 4C show front, side, and exploded views respectively of a double motor truss according to various embodiments of the invention;

FIG. 4D shows components of the double motor truss in isolation and assembled;

FIGS. 5A and 5B show front and exploded views respectively of a damper truss according to various embodiments of the invention;

FIG. 5C shows a perspective view of the damper truss of FIGS. 5A and 5B;

FIG. 6 shows another damper truss according to various embodiments of the invention;

FIG. 7 shows a screw anchor foundation component according to various embodiments of the invention;

FIGS. 8A and 8C show front and side views of a portion of a single-axis tracker according to various other embodiments of the invention; and

FIG. 8B shows a top view of a motor truss cap of FIG. 8A.

### DETAILED DESCRIPTION

The following description is intended to convey a thorough understanding of the embodiments described by providing a number of specific embodiments and details involving A-frame foundations used to support single-axis solar trackers. It should be appreciated, however, that the present invention is not limited to these specific embodiments and details, which are exemplary only. It is further understood that one possessing ordinary skill in the art in light of known systems and methods, would appreciate the use of the invention for its intended purpose.

As discussed above in the Background, the applicant of this disclosure has developed a truss-based alternative to plumb-driven H-pile foundations for supporting single-axis trackers and other structures. Known commercially as EARTH TRUSS, this foundation consists of a pair of adjacent, angled legs extending below ground on East and West sides of an intended tracker row and joined at their apex by a truss cap, adapter or bearing adapter to form a unitary A-framed-shaped foundation with the ground. Tracker bearing assemblies, drive motors, and center structures, among other components, attach to the apex component and, in some cases, to the truss legs themselves. Because trusses translate lateral wind loads into axial forces of tension and compression, they are better able to support single axis trackers than conventional H-piles and require less steel to do so.

Most tracker makers currently design their products to work with commodity H-piles of known dimensions (e.g., standard wide-flange W6×9, W6×12 galvanized steel beams). Variances in the expected top-of-pile loads are accommodated by using relatively larger beams at certain locations, driving longer beams to deeper embedment depths, or both. For example, foundations that support motors and those that include torque tube dampers may have to resist heavier loads than those supporting bearings. In order to handle these non-standard cases and to maximize market acceptance of truss foundations, the EARTH TRUSS foundation system must also accommodate variances in top-of-pile loads, preferably using standard truss components to the extent possible, and with installation processes that rely on the same installation machine.

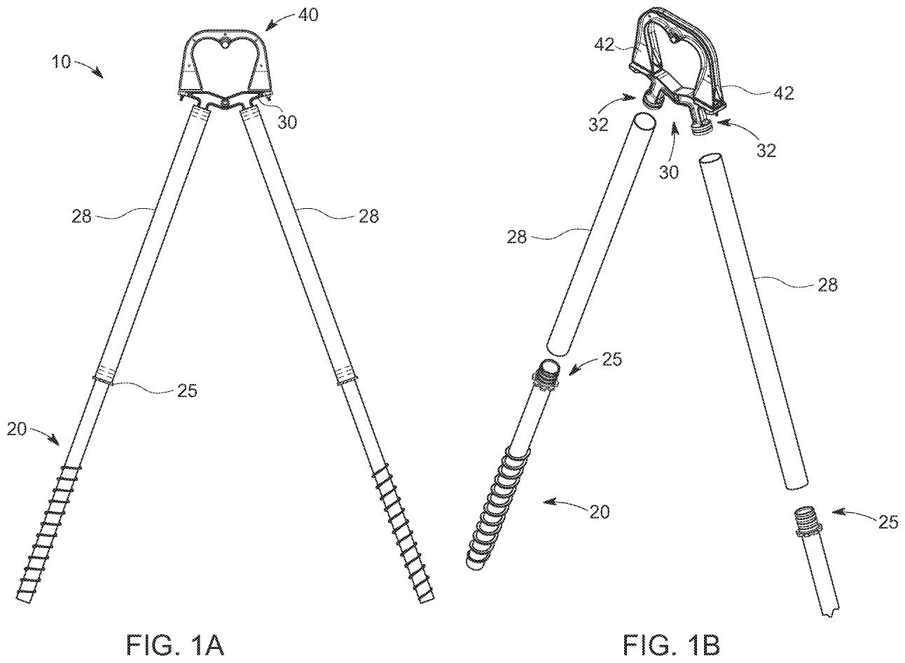

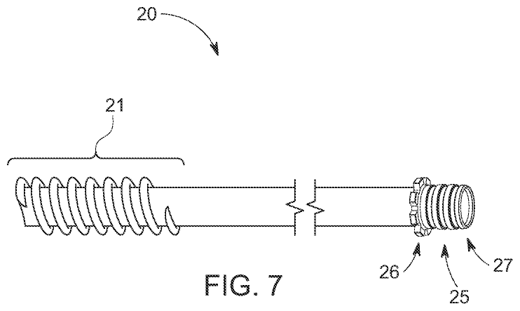

Turning now to the drawing figures, beginning with FIGS. 1A and 1B, these figures show front and exploded view respectively of a truss foundation for supporting a single-axis tracker in accordance with various embodiments of the invention. Truss foundation 10 consists of a pair of adjacent legs truss legs made up of screw anchor portion 20 and upper leg section 28. As seen in FIG. 7, screw anchor portion 20 is a length of hollow steel tube with external thread form 21 beginning at its lower end and terminating at some distance along the length of the anchor. Driving coupler 25 is affixed to the opposing end. As shown, driving coupler 25 has a set of driving features 26 circumscribing its outer surface and a connecting portion projecting away from driving features 26. In various embodiments, driving features 26 are engaged by the chuck of a rotary driver to transfer torque and downforce to the head of screw anchor 10. Also, in various embodiments, connecting portion 27 may have a slightly curved and/or oblate spheroid profile so that when is received in upper leg portion 28, the upper leg may pivot through a range of angles (e.g., 0 to 5-degrees) to enable the upper leg to correct for any misalignment of the driven screw anchor from its intended driving axis. After screw anchor 20 is driven to the desired embedment depth and only a portion of the upper end remains above-ground, coupler 25 is used to attach upper leg portion 28 by sleeving it over connecting portion 27 until it rests against driving features 26, which also serve to limit the extent of penetration of connecting portion 27 in upper leg portion 28.

Truss foundation 10 is assembled by orienting truss cap 30 in place above driven screw anchors 20 and then sleeving upper leg portions 28 over connecting portions 32 of truss cap 30 and down onto connecting portions 27 of couplers 25. The machine used to install these components is a tracked chassis machine with an articulating mast that has a rotary driver and drilling tool traveling along a common axis on the mast. The hollow profile of the screw anchor enables a drilling tool to be extended through the rotary driver and screw anchor while the anchor is being driven into the ground, to help facilitate penetration and embedment in difficult soils. Additional details of the machine and mast are intentionally omitted here but may be found in commonly assigned U.S. patent application Ser. No. 16/416,022, now issued U.S. Pat. No. 10/697,490, the disclosure of which is hereby incorporated by reference in its entirety. In various embodiments, one or more crimping devices on the machine may be used to crimp the portions of upper leg portion overlapping with connecting portions 32 of truss cap 30 and connecting portion 27 of coupler 25. Indentations circumscribing portions 32 and 25 may facilitate deformation during crimping.

Also, though not shown here, the machine used to drive the screw anchor may include a jig, clamp, holder, or other device to insure that truss cap 30 is properly aligned with other truss caps in the same tracker row and with respect to the work point of the truss so that the rotational axis of the tracker, which in this case, is the bearing pin or the bearing opening, is aligned with the work point of the truss. Such a jig, clamp, or holder may be seen, for example, in commonly assigned U.S. patent application Ser. No. 17/095,616, the disclosure of which is hereby incorporated by reference in its entirety. The work point is the point or region above the legs that a line through the center of each leg will intersect. For trusses that primarily resist lateral loads (as opposed to torque), by aligning the rotational axis with the work point, this insures that bending moments are minimized, and lateral loads are efficiently translated into axial forces of tension and compression in the legs. A typical tracker row will include several such trusses and bearing adapters spanning 300+ feet with spacing between trusses typically on the order of 20-30′.

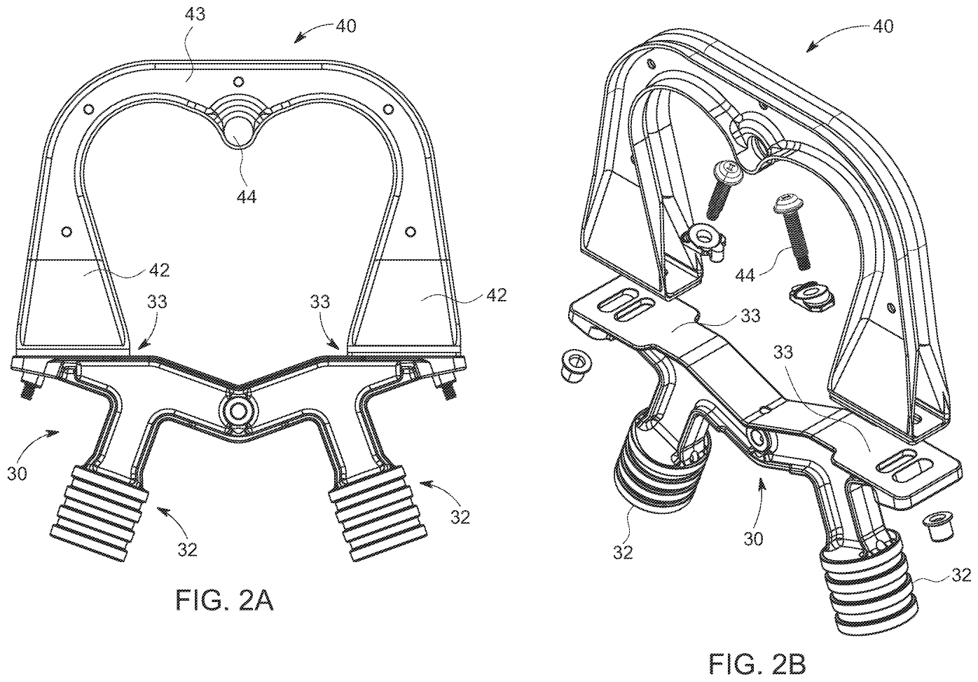

Continuing with FIGS. 1A and 1B, in this example, bearing housing assembly 40 has been attached to mounting portions 33 of truss cap 30. Bearing housing assembly 40 is a tracker component from NEXTracker, Inc. of Fremont, Calif. It has cardioid shape with a pair of legs 42 and a bearing 44 proximate to cusp 43. In the NEXTracker system, a bearing pin is inserted into bearing 44 and a pair of torque tube brackets are attached to either end of the pin to suspend the torque tube. As seen in greater detail herein, the drive motor of this tracker is offset from the torque tube so that as the tube is rotated, it swings through an arc bounded by leg portions 42, rather than rotating about its own axis. FIGS. 2A and 2B show the fitment between bearing housing assembly 40 and truss cap 30. In various embodiments, a pair of bolts or fasteners 44 are used to join bearing housing assembly 40 to truss cap 30. It should be appreciated that truss cap 30 may be specifically dimensioned to support NEXTracker bearing housing assembly 40. Different versions of truss cap 30 may be designed to support tracker components from other tracker makers. Also, in some embodiments, features of bearing housing assembly 40 may be incorporated into a truss cap 30 to form a combined structure referred to as a bearing adapter.

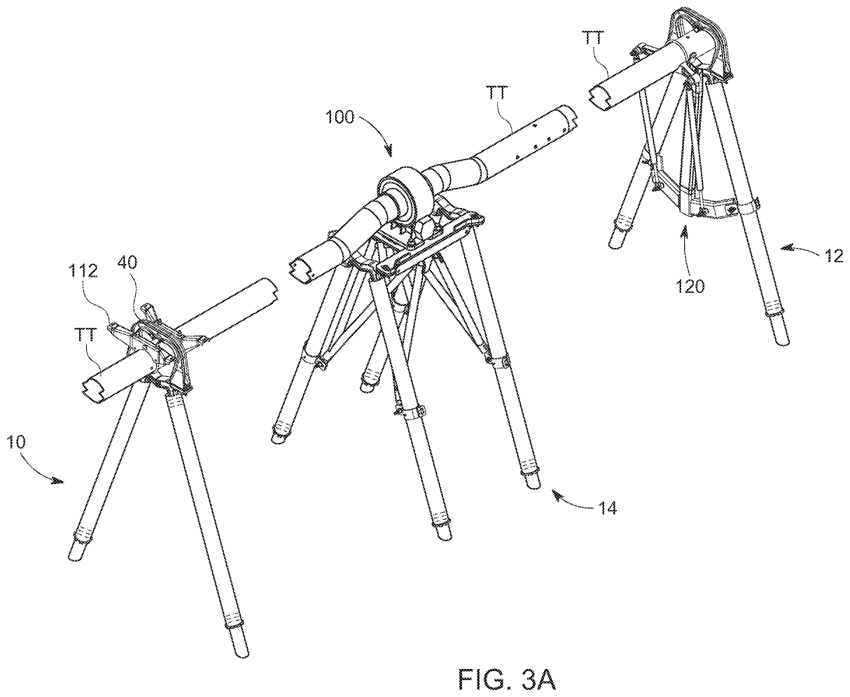

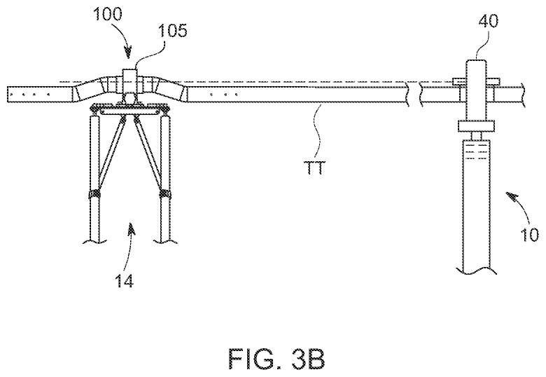

FIG. 3A shows a portion of a single-axis tracker including a standard bearing truss, motor truss and damper truss according to various embodiments of the invention. Each row of a single-axis tracker typically has a motor at one foundation point that imparts torque to the torque tube, thereby changing the orientation of the attached solar panels. In the NEXTracker system, there is a one-to-one correspondence between motors and rows. In other tracker systems, such as those available from Array Technologies Inc., of Albuquerque, N. Mex., a single drive motor moves rotates panels on multiple rows via interlinked driveshafts and center structures at each row that convert the driveshaft's rotation into movement of the torque tube. In either case, as discussed herein, tracker makers may specify that some foundations will have different top-of-pile loads than others. Unlike trusses that merely support torque tube bearings, foundations that support tracker motors, center structure, and/or those with dampers may be subjected to additional loads and/or bending moments when wind strikes the array. The components supported by these foundations may resist or dampen unintended rotation. In order to withstand these additional forces, various ones of the truss foundations in a given tracker row may be modified to accommodate these additional forces. To that end, FIG. 3A shows three different types of truss foundations supporting a portion of a tracker torque tube: standard bearing truss 10, damper truss 12, and double motor truss 14.

Starting with standard bearing truss 10, this truss is constructed of the basic truss components shown in FIGS. 1A, 1B, 2A and 2B. In this example, NEXTracker bearing housing assembly 40 is attached to truss cap 30. In addition, torque tube brackets 112 are attached to the bearing pin on either side of BHA 40. The torque tube, labeled “TT” in the drawings, is suspended form the torque tube brackets 112. As tube is turned, it swings with an arc that is bounded by the bearing housing assembly. The majority of the foundations in any given NEXTracker tracker row may take on the configuration of standard bearing truss 10.

Also shown in FIG. 3A is motor truss 14. In this case, motor truss 14 is supporting an offset drive motor assembly 100 such as that offered by NEXTracker. It should be appreciated that the principles herein are equally applicable to trackers with non-offset drive motors, that is, where the drive motor causes the torque tube to rotate at each bearing about its own axis. In the example shown here, torque tube TT curves upward so that the center of the tube at the portion that insects drive motor assembly 100 is aligned with the rotational axis of the tracker, which, in this case, is the bearing pin seated in bearing 44. This is shown more clearly in FIG. 3B where the dotted horizontal line indicates the tracker's axis of rotation.

Double motor truss foundation 14 is constructed of a pair of proximately adjacent truss foundations. In this case, proximately adjacent means ˜2 feet apart. Here, truss cap 30 is used to join the legs of each truss making up the double motor truss. Upper leg sections 28 are crimped to truss caps 30 and couplers 25 so that they present a mounting platform that is substantially orthogonal to the truss legs. In various embodiments, these truss foundations may be constructed from the same components as standard bearing truss 10, but with different truss leg angles, wider leg spacing, or both so that the work point of the truss is higher than for a standard bearing truss. This is seen, for example, in FIG. 3B, which provides a side view of the section of tracker array in 3A where the dotted line represents the tracker's rotational axis. As seen in 3B, the drive motor is offset from the remainder of the torque tube by a pair of bent sections that bend up toward the slewing drive and then down again on the opposing side. By aligning the center of the slewing drive 105 with the bearing pin, as the slew drive moves the torque tube, it swings through an arc about the pin in each BHA. At bearing truss 10, the rotational axis is the bearing pin, whereas as at motor truss 14, it is at the center of slew drive gear box 105. This configuration allows the same installation machine and truss hardware to be used to install double motor trusses that is used to install standard bearing trusses, a critical requirement for achieving scale.

To enable motor truss 14 to withstand greater forces than possible with standard truss 10, a pair of double truss brackets 115 are used to join the adjacent truss pair in the North-South direction at their respective East-West oriented truss caps. Then a pair of leg braces 110 are attached to each truss via leg brackets 111 at the lower end and to the pair of double truss brackets 115 at the upper end via mounting surfaces 117. Together this forms a rigid structure that is able to handle lateral loads as well as the bending moments and/or torque present at the drive motor using the same driving methodology with only two additional components, braces 110 and motor truss brackets 115.

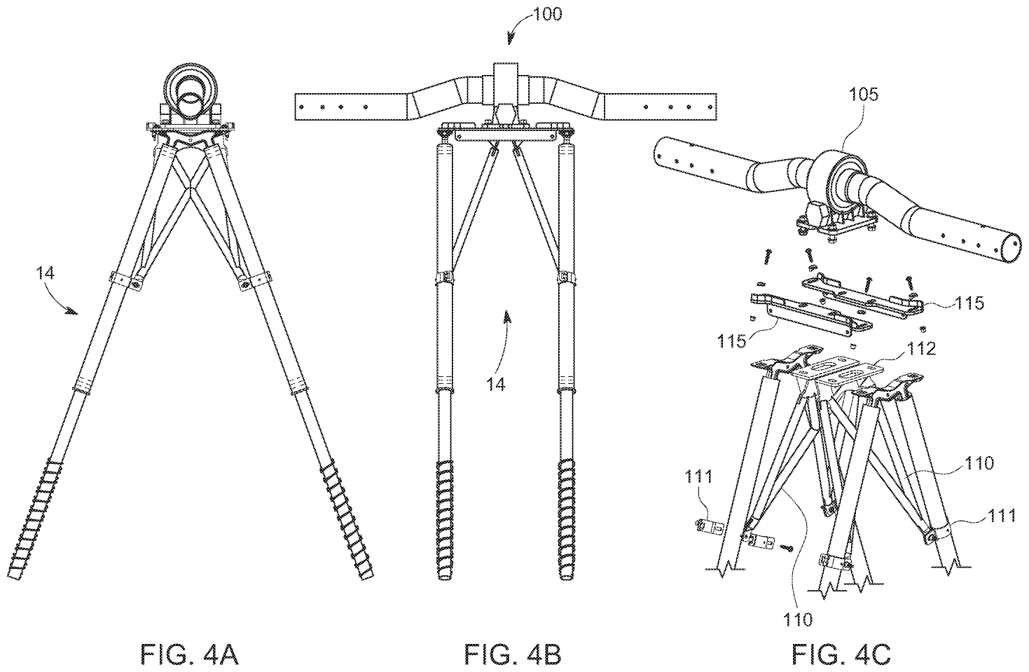

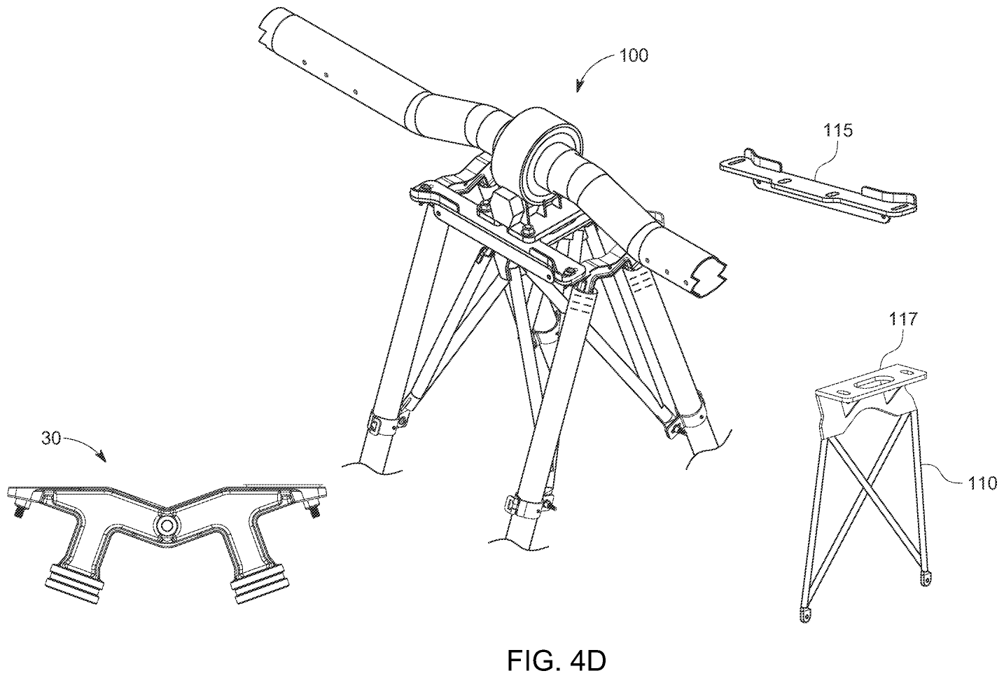

FIGS. 4A-4C show front, side, and exploded views of motor truss 14 and its components; FIG. 4D shows the motor truss components in isolation and as an assembled unit. Slewing motor and gear assembly 105 provides the torque to rotate the torque tube. In various embodiments, motor truss components will be installed contemporaneous to installation of the truss foundation so that when the truss foundation crew is finished, the foundations are ready to receive the tracker components.

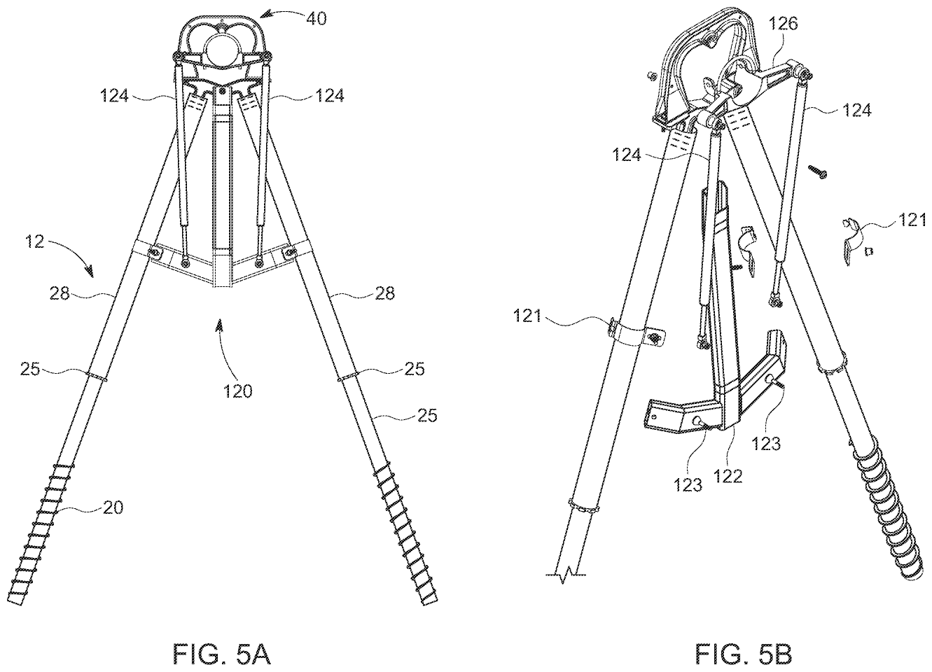

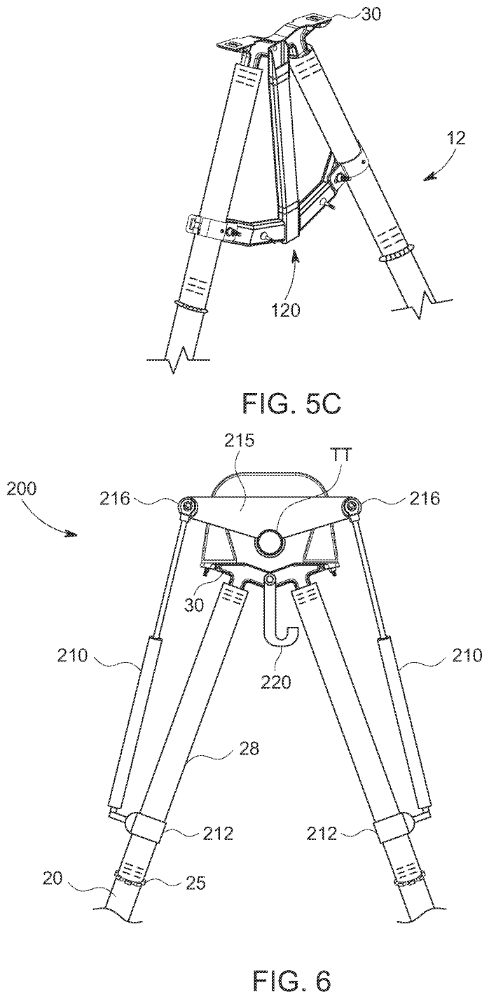

Returning to FIG. 3A, this array also includes damper truss 12. Damper truss 12, as shown, is a standard bearing truss that has been modified to include damper components that translate the additional forces generated by damping unintended movement of the torque tube into axial forces in the truss legs. These components are shown in greater detail, for example, in FIGS. 5A, 5B, and 5C which, show front, exploded, and perspective views respectively of damper truss 12 in accordance with various embodiments of the invention. After the standard truss has been assembled, damper brace assembly 120 is attached to legs of truss via leg brackets 121. In the example of FIGS. 5A-C, damper assembly 120 consists of a pair of horizontal braces connected to respective ones of the truss legs, via leg brackets 121 and a single vertical brace extending from the horizontal braces up to the truss cap to form brace 122 having an inverted T-shape or arrow shape. The upper end of vertical brace is connected to the approximate center of truss cap 30. In various embodiment, and as shown herein, an opening may be predrilled or otherwise formed in truss cap 30 to accommodate a huck bolt, rivet, or other fastener for securing the vertical portion of brace 122. The horizontal portions may have a pair of mounting posts 123 that serve as the fixed connection point for damper springs 124. After bearing housing assembly 40 has been attached to truss cap 30, and torque tube TT suspended via torque tube mounting brackets, a torque tube damper bracket such as bracket 126 may be attached to the torque tube proximate to bearing housing assembly 40 so that movement of the torque tube requires extension of one damper spring 124 and compression of the other. The resistance provided by damper springs 124 will dampen unintended motion of the torque tube and will transfer these forces into the truss legs via leg brackets 121.

Depending on the requirement of the particular tracker maker, dampers may be used on every foundation, that is on all standard bearing trusses 10, or only on a subset of the total foundations in a given row. Although a pair of damper springs 124 may be used as shown, it should be appreciated that in other embodiments, a single damper spring may be used, such as in the Array Technologies tracker. As shown, the lower end of each damper spring 124 is attached to mounting pin 123 of brace 122 proximate to each leg. In this way, unintended rotation of the torque tube, such as in response to wind gusts, snow loads, bird loads or otherwise, can be resisted by tension and compression in the truss legs. The truss foundation better aligns these forces than dampers attached to a single monopile.

Turning now to FIG. 6, this figure shows another application of the truss foundation. In this case, truss 200 is supporting a NEXTracker type bearing housing assembly 40. In this Figure, the damper assembly 120 has been replaced with a pair of damper leg brackets 212 without the brace assembly 120. Mounting pins project out of each leg bracket 212. A pair of linear actuators 210 are attached at the lower end to each mounting pin and at the other end to ends 216 of actuator bracket 215. Actuator bracket 215 is attached to the torque tube TT. In some embodiments, actuator bracket 215 and linear actuators 210 may simply function as dampers to resist unintended movement of the torque tube. That is, they allow the tracker to rotate slowly but resist sudden impulsive movements. In other embodiments, linear actuators 210 may be used to assist with stowing the array, that is when the array is moved to an optimal stow angle, such as parallel to the ground. The particular stow angle used may vary from tracker to tracker. When stowing the damper may function as a brake to prevent rotation away from the stow angle. Finally, in still further embodiments, linear actuators 210 may be used to rotate the tracker, that is, in place of a clewing drive or other drive assembly. A pair of such actuators 210 may installed on every truss supporting the array or on a subset of the total number of trusses in each row. They may be controlled via a wireline or wireless communication array or mesh network to achieve synchronized motion.

Truss 200 shown in FIG. 6 also includes wire hook 220 hanging from the center of truss cap 30. In this example, wire hook 220 is shown as hanging below truss cap 30. In other embodiments, it may be attached to or near one of the truss legs or to a portion of the truss cap that is above the truss legs, such as on either side outside of the connecting portions. In some embodiments, actuator bracket 216 may also be used to attach solar panels to the torque tube. In other embodiments, separate U bolts or other fasteners may be used for that purpose.

As discussed herein, because a standard truss is primarily resisting the weight of the tracker and any lateral load due to wind, aligning the rotational axis of the standard truss with the work point minimizes any moments on the truss. By contrast, the motor truss does experience moments because the motor is the primary structure resisting wind rotation and those forces are transferred into the foundation. Although the motor or double truss provides one method of dealing with the torque or bending moments experienced at the motor, it is not the only way. In some cases, it may be possible to resist these moments by aligning the rotational axis of the slewing drive at the motor truss below the work point of the standard truss supporting it. By lowering the motor's axis of rotation, in this case, the center of the slewing drive, below the work point of the truss supporting it, the motor truss is better able to resist the moment because the length of the lever arm is reduced, and the forces are spread out over a wider distance in the horizontal direction. It should be appreciated, however, that this exemplary only and that the motor truss legs may be at different angles than the standard truss legs and also may have the same spacing.

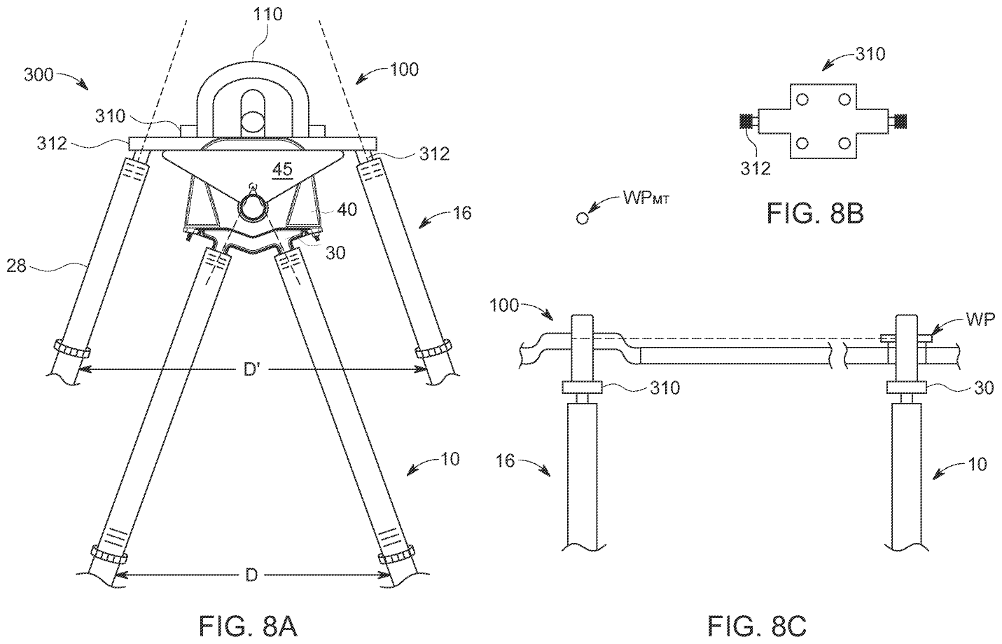

To that end, FIGS. 8A and 8C shows a portion of single-axis tracker 300 supported by truss foundations according to various other embodiments of the invention. In this example, standard bearing truss foundation 10 is shown supporting torque tube bearing housing assembly 40. Truss cap 30 is used to join the truss legs and bearing housing assembly 40 sits atop truss cap 30. The truss legs are separated by a moderate angle, such as one in the range of 60-72.5 degrees and are spaced apart such that at the point that the screw anchors penetrate the ground is separated by a distance D. A torque tube is suspended from bearing housing assembly 40 by a torque tube (TT) bracket 45 connected to a bearing pin passing through the BHA. This bracket may be used to connect to dampers, to solar panels, or to both as discussed herein. Behind standard bearing truss 10 in the same row is single motor truss 16. Unlike double motor truss 14 shown elsewhere herein, single motor truss 16 consists of only a single pair of truss legs. However, unlike the standard truss 10, the legs of motor truss 16 are further spread out than those of standard truss 10 to a distance D′ at the point where they enter the ground. This has the effect of raising the work point of motor truss 16 as seen in FIGS. 8A and 8C. It should be appreciated that this may also be accomplished by increasing the truss leg angle (e.g., making it steeper) or by doing both. Like standard truss 10, the legs of motor truss 16 consist of screw anchors and upper legs portions, however, in the case of motor truss 16, the legs are joined together by motor mount 310, which is essentially a wider truss cap that provides a planar mounting surface for slewing drive and gear assembly 110. Slewing drive and gear assembly 110 sits atop motor mount 310. Like truss cap 30, motor mount 310 has a pair of connecting portions 312 extending below and away from it that are received in respective upper leg sections 28. In various embodiments, the legs of motor truss 16 are spaced far enough apart so that as the torque tube passes through slewing drive and gear assembly 110, the center of the tube is aligned the with the rotational axis of the rest of the tracker, that is, the bearing pin, but not with the work point of the motor truss.

The embodiments of the present inventions are not to be limited in scope by the specific embodiments described herein. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A system for supporting a tracker drive motor comprising:
a first truss foundation;
a second truss foundation;
a pair of leg braces connected to respective ones of the first and second truss foundations; and
a pair of double truss brackets interconnecting the first and second truss foundations and the pair of leg braces to provide a tracker motor mounting surface that resists lateral loads and bending moments.

2. The system according to claim 1, further comprising a tracker drive motor on the mounting surface.

3. The system according to claim 1, further comprising a torque tube rotatably attached to the drive motor.

4. The system according to claim 3, further comprising a plurality of third truss foundation, each third truss foundation rotatably supporting the torque tube.

5. The system according to claim 4, wherein at least one of the plurality of third truss foundations comprises a damper assembly.

6. The system according to claim 5, wherein the damper assembly comprises a brace and at least one damper spring attached to the brace to retard movement of the torque tube.

7. The system according to claim 5, wherein the damper assembly comprises a pair of damper springs connected to legs of at least one of the plurality of third truss foundations.

8. The system according to claim 7, where in the damper springs are operable to stow the array.

9. A single axis tracker comprising:
a plurality of first standard truss foundations, each first standard truss foundation supporting a tracker torque tube so that a rotational axis of the tracker torque tube is aligned with a work point of the standard truss; and
at least one motor truss foundation supporting a tracker motor assembly so that a rotational axis of the tracker motor is positioned below a work point of the motor truss, wherein the at least one motor truss foundation comprises a pair of interconnected adjacent truss foundations.

10. The single-axis tracker according to claim 9, wherein the at least one motor truss comprises a pair of leg braces each connected to one truss of the pair of interconnected adjacent truss foundations.

11. The single-axis tracker according to claim 10, wherein the at least one motor truss comprises a pair of truss brackets interconnecting the pair of interconnected adjacent truss foundations and the pair of brace assemblies.

12. A single axis tracker comprising:
a plurality of first truss foundations, each first truss foundation comprising a pair of angled truss legs joined together with a first truss cap and supporting a bearing assembly of the tracker;
at least one second truss foundation, the at least one second truss foundation comprising a pair of angled truss legs joined together with a second truss cap and supporting a torque tube drive motor assembly.

13. The single-axis tracker according to claim 12, wherein each of the first truss foundations aligns a rotational axis of the tracker with a work point of the first truss foundation;

14. The single axis tracker according to claim 12, wherein the at least one second truss foundation aligns the rotational axis of the tracker below a work point of the at least one second truss foundation.

15. The single axis tracker according to claim 12, where at least one of the first truss foundations comprises a damper assembly.

16. The single-axis tracker according to claim 15, wherein the damper assembly comprises a damper bracket extending from legs of the at least one first truss foundation to the truss cap, and a torque tube bracket interconnected to the damper bracket via at least one damper spring.

17. The single-axis tracker according to claim 15, wherein the damper assembly comprises a pair of springs extending from legs of the least one first truss foundation to a torque tube of the single-axis tracker via a torque tube bracket.

18. The single-axis tracker according to claim 12, wherein each of the first truss foundations has a common work point and the at least one second truss foundation has a separate work point, higher than the common work point.
